(19) United States
(12) Patent Application Publication
(10) Pub. No.: US 2010/0180738 A1
(43) Pub. Date: Jul. 22, 2010

(54) LIQUID CUTTING DEVICE

(76) Inventor: Michael Tavger, Katzrin (IL)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/357,508

(22) Filed: Jan. 22, 2009

(51) Int. Cl. B26F 1/00

(52) U.S. Cl. 83/53; 83/177

(57) ABSTRACT

A liquid cutting device employing pressurized working liquid which includes a nozzle assembly. The assembly includes a plurality of liquid jet nozzles, each nozzle of which has a nozzle axis. The plurality of nozzles are arranged so that their nozzle axes intersect at an intersection point located at a predetermined distance downstream from the nozzles. The device also includes an apparatus for delivering the pressurized working liquid to the nozzles. Each of the nozzles is configured to selectably emit a liquid jet operative to cut through a target material. The liquid jets emitted from the nozzles interfere and disperse each other when meeting at the intersection point and the liquid jets are atomized. The device includes a spacer element adjustably mounted onto the nozzle assembly, which increases or decreases the cutting depth of the device. A method for employing the liquid cutting device is also discussed.

### FIELD OF THE INVENTION

The present invention relates to a liquid cutting device which inter alia is usable for surgical procedures.

### BACKGROUND OF THE INVENTION

Liquid jets, primarily water jets, have been used in industry for years as the basis for cutting instruments. A water jet cutter is a tool able to slice into various solid materials with the help of a high speed water jet which sometimes may include abrasive materials. The design of water jet cutting devices is simple. Usually, the water pumping system employs ultra-high pressure pumps, which can deliver pressures between about 270 MPa and about 600 MPa. The water or water-abrasive mix exits the nozzle of the device at extremely high speeds. As it impacts the surface of the material that is to be cut, it starts stripping tiny bits of matter away from it, creating what we observe as a cut in the material.

Water jet technology has also been adapted for use in different areas of medicine. It has been found that the use of a water jet in surgery has high tissue selectivity, avoids trauma in surrounding tissue, produces minimal hemorrhaging, and allows for shorter surgical procedure times. Water jet systems typically use saline solution to cut through tissue. Adjustments to the pressure level allow the surgeon to selectively cut through organ parenchyma, but not other structures. Water jet devices often include an aspiration tube to remove tissue debris and liquid as cutting occurs.

A typical water jet apparatus employed in surgical procedures uses the general principles of industrial water jet cutting but has been reduced to surgical size. By pumping sterile saline solution at 10,000 to 20,000 psi (about 69 MPa to about 138 MPa) the system removes tissue from areas that are difficult to debride surgically, such as areas with dead necrotic tissue. These water jet surgical apparatuses often allow the user to treat both flat and raised wounds.

One such surgical water jet handpiece is held lengthwise along the tissue's surface when in operation. Water is propelled onto the entire length of the wound bed. However, the tissue's surface is usually uneven, and the jet is unable to selectively treat wound tissue while avoiding debridement of healthy or healing tissue. Therefore, in many complicated cases when gentle and selective debridement is needed, use of such technology can cause injury.

For concave shaped wound surfaces, debridement with typical water jet cutting surgical tools is problematic, often damaging surrounding tissue, especially when the tissue being cut has a large area. Since wound conditions vary, especially for wounds having large areas, more precise water jet debridement surgical systems than are currently available are needed.

Prior art water jet surgical devices also exhibit the problem of splashing liquids and contamination from diseased, debrided wounds which may infect the surgical and operating room environment.

As noted above, the debridement procedure in prior art water jet systems generally debrides still living tissue in the area of necrotic or infected tissue and also destroys underlying healthy tissue. In order to conserve still living tissue, access to tissue to be debrided must be more flexible, versatile and safe than in prior art devices. More discriminating debridement devices and systems are needed. It would be advantageous that such systems would reduce the attendant health risks arising from debridement debris. Additionally, it would be advantageous to develop a device that employs single use parts that are inexpensive to fabricate.

### SUMMARY OF THE PRESENT INVENTION

It is an object of the present invention to provide a liquid cutting device which allows for easier three-dimensional cutting and better control of cutting depth and cutting width. The device allows for cutting larger areas than prior art systems and devices.

It is an object of the present invention to provide a liquid cutting device for use in surgical procedures which when cutting diseased tissue only minimally cuts healthy tissue.

It is a further object of the present invention to provide a liquid cutting device that requires lower pressures than prior art devices to cut target surfaces.

It is yet another object of the present invention to provide a device which can substantially eliminate splashing of waste working liquid and solid debris resulting from the cutting process.

In one aspect of the present invention there is provided a liquid cutting device employing a pressurized working liquid including: a nozzle assembly comprising a plurality of liquid jet nozzles, each nozzle of which has a nozzle axis. The plurality of nozzles is arranged so that the nozzle axes intersect at an intersection point located at a predetermined distance downstream from the nozzles; and apparatus for delivering the pressurized working liquid to the plurality of liquid jet nozzles, each nozzle being configured to selectably emit a liquid jet operative to cut through a target material, wherein the liquid jets interfere with and disperse each other when meeting at the intersection point.

In embodiments of the device of the present invention, the liquid cutting device includes a plurality of nozzles arranged about an assembly axis which intersects with the nozzle axes at the intersection point, and the nozzles lie in a jet emission plane normal to the assembly axis and spaced from the intersection point, and wherein the cutting depth of the cutting device is not greater than the axial distance from the jet emission plane to the intersection point. In some instances of this embodiment, the device also including a spacer element adjustably mounted onto the nozzle assembly, the spacer element being selectably extendable such that a front end portion thereof extends beyond the jet emission plane towards the intersection point, thereby increasing the available cutting depth to a desired cutting depth.

In yet another embodiment of the device, the device further includes a driver element in mechanical communication with the nozzle assembly thereby to rotate the assembly allowing the nozzles positioned therein to cut a three-dimensional conical section.

In some embodiments of the device, the spacer element is a translationally movable element, while in others, the spacer element is a rotationally movable element.

In still another embodiment of the present invention, the device is in vacuum communication with a vacuum source operative to suction off waste working liquid and debris resulting from the cutting operation.

In yet another embodiment of the device, the spacer element further includes a plurality of apertures to allow entry of air which under suction carries away the debris of the cutting process and waste working liquid.

In another embodiment of the device, the nozzle assembly is positioned in a jet dispenser element, the dispenser element including a plurality of slots to allow entry of air which under suction carries away the debris of the cutting process and the waste working liquid.

In embodiments of the device of the present invention, the device further includes a spacer element adjustably mounted onto the nozzle assembly. The spacer element is selectably extendable so that a front end portion thereof extends beyond the plurality of nozzles in the direction of the intersection point, thereby varying the available cutting depth to a desired cutting depth.

In still another embodiment of the device, the device is in vacuum communication with a vacuum source operative to suction off waste working liquid and debris resulting from the cutting operation.

In some embodiments of the device, the target material is mammalian tissue.

In a second aspect of the present invention there is provided a method for cutting a target material with a liquid cutting device including a spacer element having a distal edge and a plurality of nozzles, each nozzle emitting a pressurized liquid jet stream from its jet emitting end with the jet streams intersecting at a predetermined point. The method comprises the steps of: adjusting the position of the spacer element so that the plurality of nozzles is spaced from the distal edge of the spacer element such that the position of the intersection point of the liquid jets allows for a preselected cutting depth within the target material; placing the distal edge of the spacer element so as to contact the target material; and activating the device.

In one embodiment of the method, the method further includes the step of: deactivating the device and repeating said steps of adjusting, placing and activating, wherein said step of deactivating and repeating is repeated as often as required.

In another embodiment of the method, the step of adjusting includes the step of translating the spacer element so that the position of the intersection point of the liquid jet streams emitted from the plurality of nozzles allows for the preselected cutting depth within the target material.

In yet another embodiment of the method, the step of adjusting includes the step of rotating the spacer element so that the position of the intersection point of the liquid jet streams emitted from the plurality of nozzles allows for the preselected cutting depth within the target material.

In still another embodiment of the method, the method further includes the step of activating a suction source for suctioning off waste working liquid and debris produced by cutting the target material.

In yet another embodiment of the method, the method may further include the step of translating the device in a direction substantially along a line within a plane containing the jet emitting ends of two nozzles and the predetermined intersection point, thereby forming a narrow trench-shaped shape cut.

In still another embodiment of the method, the method may further include the step of translating the device in a direction substantially normal to a plane containing the jet emitting ends of two nozzles and the predetermined intersection point, thereby forming a cut having a triangular prismatic-shaped.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in the cause of providing what is believed to be the most useful and readily understood description of the principles and conceptual aspects of the invention. In this regard, no attempt is made to show structural details of the invention in greater detail than is necessary for a fundamental understanding of the invention. The description taken with the drawings make apparent to those skilled in the art how the several forms of the invention may be embodied in practice.

In the drawings:

FIGS. 1A-1C illustrate the principle of operation of a liquid cutting device constructed according to the present invention;

FIG. 1D further illustrates the principle of operation of a liquid cutting device constructed according to the present invention;

FIGS. 1E-1F illustrate the principle of operation of a liquid cutting device constructed according to the present invention as the device moves in orthogonal directions;

FIG. 2A illustrates an exploded view of a liquid cutting device constructed according to a first embodiment of the present invention;

FIG. 2B is an isometric view of the device shown in FIG. 2A;

FIG. 3A is a perspective view of the liquid jet dispenser section of the device constructed according to the embodiment of FIGS. 2A-2B;

FIG. 3B is an enlarged view of the distal end of the liquid jet dispenser section shown in FIG. 3A;

FIG. 4 shows a cross-sectional view of the distal end of the liquid cutting device constructed according to FIGS. 2A-3B;

FIGS. 5A-5C illustrate the result of retracting the spacer element of the liquid cutting device constructed according to the embodiment of FIGS. 2A-4 on cutting depth and cutting width;

FIG. 6A shows an isometric view of a liquid cutting device constructed according to a second embodiment of the present invention;

FIGS. 6B-6C are a sectional view of the device and an enlarged view of the distal end of the device, respectively, constructed according to the embodiment shown in FIG. 6A;

FIGS. 7A-7B show two cross-sectional views of the instrument presented in FIGS. 6A-6C, the views being offset by 90°;

FIG. 8 is a schematic view of a system containing a liquid cutting device constructed according to embodiments of the present invention;

FIG. 9A illustrates the effect of using a prior art water jet cutting device; and

FIG. 9B illustrates the effect of using a liquid cutting device constructed according to the present invention.

Similar elements in the Figures are numbered with similar reference numerals.

### DESCRIPTION OF PREFERRED EMBODIMENTS

The present invention inter alia provides a liquid cutting device including a liquid jet nozzle assembly configured to allow for three-dimensional cutting of target surfaces. Without intending to limit the invention, the liquid jet nozzle device allows for tissue debridement in surgical procedures. The jet nozzle assembly is comprised of a plurality of nozzles. The liquid jet exiting end of each of the plurality of nozzles form what herein is referred to as a jet emission plane.

Each nozzle of the plurality of nozzles is angled so that the liquid jet it emits intersects at a common point with the jets of the other nozzles, herein also denoted as the intersection point. The jet emission plane is perpendicular to the principal axis of the jet nozzle assembly. This axis may also be referred to herein as the assembly's assembly axis. The axis may also be referred to as the longitudinal axis, reflecting its extension in the direction of the longest horizontal dimension of the device.

Typically, but without intending to limit the invention, the plurality of nozzles is usually two or more identical cylindrically symmetrical oblique nozzles. It should readily be appreciated by one skilled in the art, that jet nozzles having other shapes may also be used.

In some embodiments, the plurality of nozzles is distributed in a circle and each of the nozzles of the plurality of nozzles may be distributed equidistantly from its nearest neighbors in the circle. Typically, the distance from each of the nozzles in the plurality of nozzles to the common intersection point is the same.

The plurality of nozzles is in liquid communication with the same or different working liquid source(s) from which a working liquid is provided under high pressure. The apparatus for connecting the plurality of nozzles, herein at times denoted as apparatus for delivering a working liquid, includes water channels which are in turn connected to a water tube conveying a pressurized working liquid from at least one working liquid source.

The liquid jet nozzle assembly is equipped with a movable liquid jet positioning means, herein also denoted as a movable spacer element. As will be described in greater detail below, the spacer element allows for the plurality of nozzles to be positioned closer to or more distant from the surface of the target material being cut or otherwise abraded, ablated or debrided.

As with prior art water jet cutting instruments as high a velocity of the liquid, and therefore as high an energy, as possible is desirable. It is readily understood that higher pressures translate into higher velocities. Additionally, premature atomization of the liquid jets generated by the jet nozzles of the nozzle assembly of the present invention is undesirable and is negligible as is spreading of the emitted jets before they impinge on the target material.

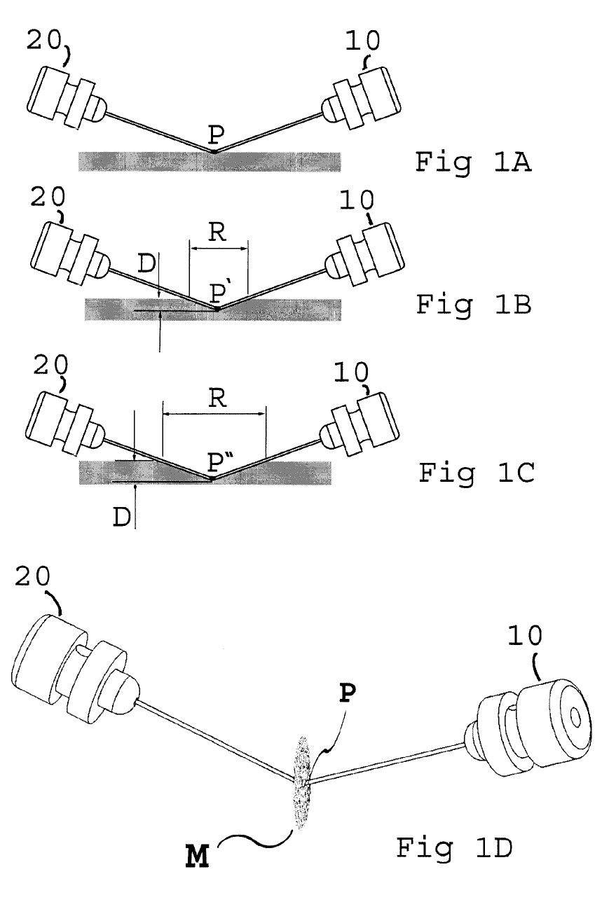

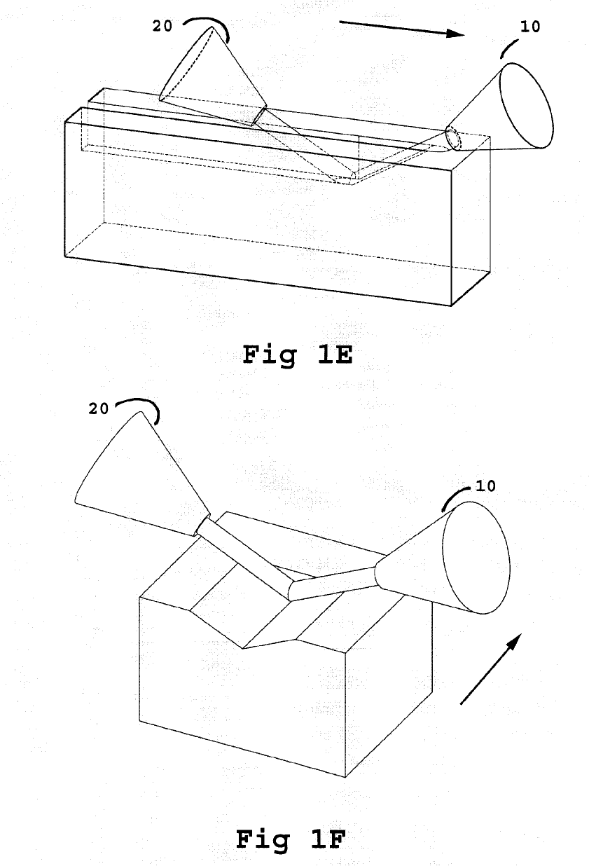

As shown in FIGS. 1A-1C, to which reference is now made, the liquid jets emitted by a pair of liquid jet nozzles 10 and 20 meet at a common intersection point. The positioning and angling of the nozzles is preselected. The intersection point in FIGS. 1A-1C is shown as P, P′ and P″, respectively. The liquid jets are shown as trajectory lines in FIGS. 1A-1C. However, it should readily be appreciated by those skilled in the art that each of the jet streams of working fluid is substantially cylindrical in shape during its flight from the nozzle from which it has been emitted until it reaches intersection point P where it is atomized.

When the plurality of nozzles is disposed symmetrically, as for example on a circle, the intersection point is typically on the line, that is the axis, passing through the center of symmetry and normal to the plane containing the nozzles. When the plurality of nozzles is disposed on a circle, the intersection point is typically on the line passing through the center of the circle and normal to the plane of the circle. The line is typically the assembly axis and it passes through the intersection point. As can be seen in moving from FIGS. 1A to 1C, the cutting width R increases and the intersection point P, P′ and P″, respectively, is found at a greater cutting depth D within the target material.

Reference is now made to FIG. 1 D which shows the intersection of two jets at an intersection point P, each jet provided by a different nozzle of the nozzle assembly. The superfine liquid mist M formed at intersection point P expands radially from that point. Upon impact, the energy of the plurality of liquid jets is reduced as energy is transferred and used to atomize the jets thereby eliminating their cutting ability.

While FIGS. 1A-1D show and the discussion in conjunction with these Figures indicate that two nozzles are present, the present invention and the principles of its operation apply to devices where the plurality of nozzles may be three or more nozzles.

The target material is cut and abraded all along the jets' trajectories up to the jets' intersection point. At that point, after their collision, the jets lose their initial cylindrical shape and a liquid sheet forms. The liquid expands radially from the jets' intersection point forming a liquid sheet which is quickly atomized into droplets having no cutting ability.

It should be appreciated that when the liquid cutting device is positioned substantially transverse to a surface of a target material and translated in a direction perpendicular to the assembly axis described above and coplanar to a plane containing the jet emission ends of nozzles 10 and 20 and intersection point P in FIG. 1A (or P′ or P″ in FIGS. 1B-1C, respectively), a narrow trench is obtained in the target surface as shown in FIG. 1E. Further, when the liquid cutting device is translated in a direction normal to this plane, a wider substantially triangular prismatic trough, also describable as a substantially synclinal-shaped trough, may be obtained in the target surface as shown in FIG. 1F. A cross-sectional profile of this triangular prismatic trough is shown in FIGS. 1B and 1C while a perspective view of the trough is shown in FIG. 1F. Therefore, the cutting width of the liquid cutting device may be said to range from a minimum width represented by the diameter of the substantially cylindrical liquid jet streams emitted to a maximum width represented by the spacing between the nozzles. It should also readily be appreciated that the liquid cutting device may be held obliquely to the surface of the target material, and depending on the direction of translation of the device, cuts of different shapes and widths analogous, but not necessarily identical, to the above described narrow trench and synclinal-shaped trough may be produced.

It should be appreciated by one skilled in the art that that the nozzle arrangement of the present invention, if only because of the presence of a plurality of nozzles, allows for the use of lower pressures in the required pressurized liquids than prior art liquid jet nozzle assemblies.

As will be discussed further below, any number of different types of adjustably movable spacer elements can be used to control the cutting depth D and the intersection point P of the nozzle assembly within the target material. As in FIGS. 1A-1C, the angle of incidence between the nozzle and the surface of the target material being cut is always substantially the same, differences only arising from the natural topographic variations in the surface or the natural distribution of the physical/chemical properties of the surface. However, in proceeding from FIG. 1A to FIG. 1C the cutting depth D within the target material increases. As will be further discussed below, the use of a spacer element controls the cutting depth D. It also affects the cutting width R of the device as illustrated in FIGS. 1A-1C and 1E-1F.

The nozzle configuration of the present invention allows for better three-dimensional cutting beneath the surface of the target material, including, for example, mammalian tissue, than with prior art instruments.

For better control and coverage of the intended treatment area, in some embodiments of the present invention the liquid jet nozzles may be rotated. The present invention contemplates embodiments employing such rotation.

The term “liquid” when appearing in the text above or below contemplates any liquid, aqueous or non-aqueous, or solution thereof. These latter may inter alia include saline solutions and solutions containing medicaments or vitamins when treating mammalian tissue. Therefore, the use of the terms “water” or “liquid” or “solution” herein is deemed to be equivalent and interchangeable without distinction unless stated otherwise. Additionally, the term “liquid” may be used in place of and as a short hand for “working liquid” without any distinction. In some cutting applications, the water/liquid/solution may also include abrasives.

While the term “cutting”, and derivatives thereof such as “cut”, is generally used herein for the operation of the devices constructed according to the present invention, terms such as “abrasion”, “ablation” and “milling”, and derivatives thereof such as “abrade”, “ablate”, and “mill”, may also be used. These should be deemed as essentially equivalent and interchangeable without distinction unless stated otherwise. “Debridement” and its derivatives such as “debride” and “debriding” are also equivalent to the terms listed above but refer, in the normal use of those terms, solely to surgical applications.

In the discussion herein, “distal” represents the direction or end of the device further from the user, or equivalently, closer to the target material. Similarly, “proximal” represents the direction or end of the device closer to the user, or equivalently, further from the target material.

When the term “target material” is used herein it may refer to any solid material including, but not limited to, biological tissue including mammalian tissue.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It is to be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

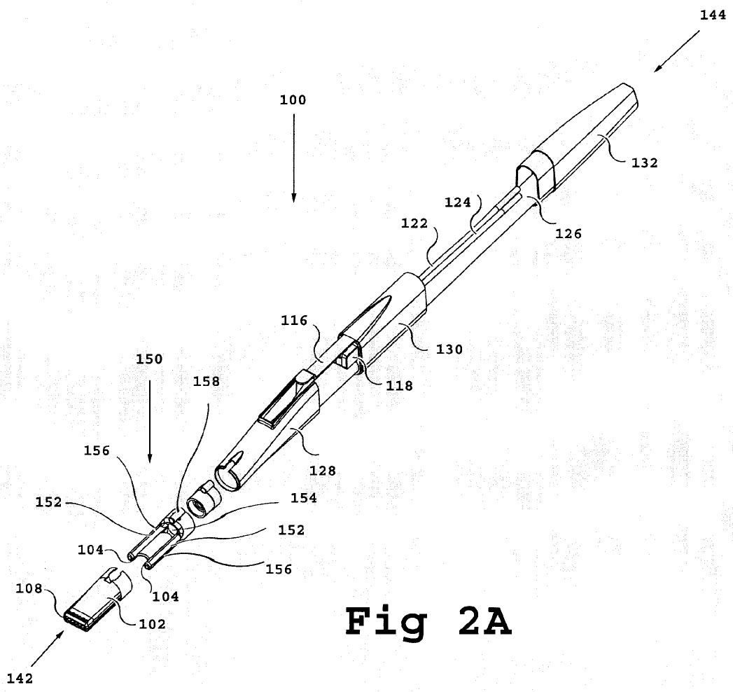

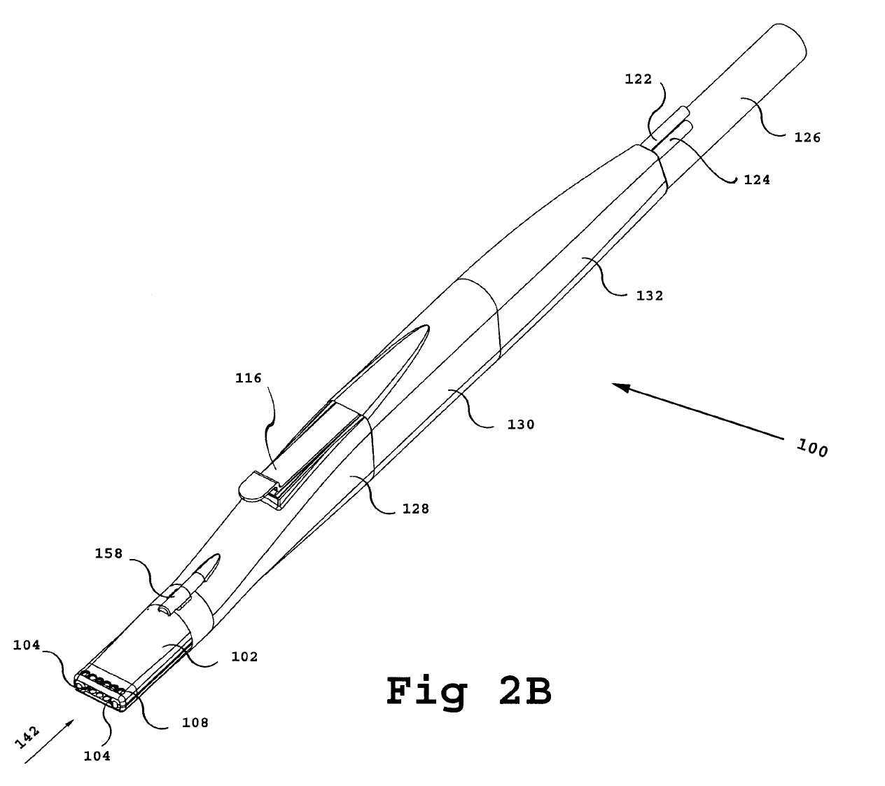

Reference is now made to FIGS. 2A and 2B where a liquid cutting device 100 constructed according to a first embodiment of the present invention is shown. FIG. 2A is an exploded view and FIG. 2B is a complete view of the embodiment.

Spacer element 102 covers liquid jet dispenser 150 (FIG. 2A) which includes a nozzle assembly including a pair of nozzles 104. Each of nozzles 104 is in liquid communication with liquid channels 152 (FIG. 2A) which in turn are in liquid connection with a liquid source (not shown) via liquid tube 122. Channels 152 and tube 122 form an apparatus for delivering a pressurized working liquid from a liquid source to nozzles 104. Suction aperture 154 (FIG. 2A) is located within dispenser 150. Positioned on the outside of liquid jet dispenser 150 is a suction tube socket 158 in vacuum connection to a vacuum source (not shown) via suction tube 126. Abrasion debris and waste working liquid are drawn into aperture 154 and pass through suction tube 126 which is connected at suction tube socket 158.

Liquid cutting device 100 is formed of distal housing 128, medial housing 130 and proximal housing 132. The proximal end 144 (FIG. 2A) of device 100 is the end of device 100 near the user while the distal end 142 of the device is the end near the target material being cut when device 100 is in use. Distal end 142 of device 100 typically contacts or is brought adjacent to, the surface of the target material being cut.

Extending from proximal end 144 of device 100 are liquid tube 122 and suction tube 126. Extending from optical switch 118 (FIG. 2A) are wires 124 which also exit from distal end 142 of device 100. Slotted optical switch 118 includes a LED and transistor sensor with a shutter between them. When optical switch activator 116 is activated, the shutter blocks light emitted from the LED and directed toward the sensor. When activator 116 is manually pressed, switch 118 also activates a high pressure pump (not shown) and a vacuum source (also not shown).

The depth of the cutting treatment is adjusted by moving spacer element 102. Air holes 108 located on the distal end of spacer element 102 allow air, waste working liquid, and abraded debris to be drawn into device 100 preventing undesirable splashing while also assisting in evacuation of the debris and waste liquid. Due to the angle between the jet flows from nozzles 104 and the tissue surface, splashing is advantageously reflected back from the tissue and carried away by the air brought into device 100 via air holes 108.

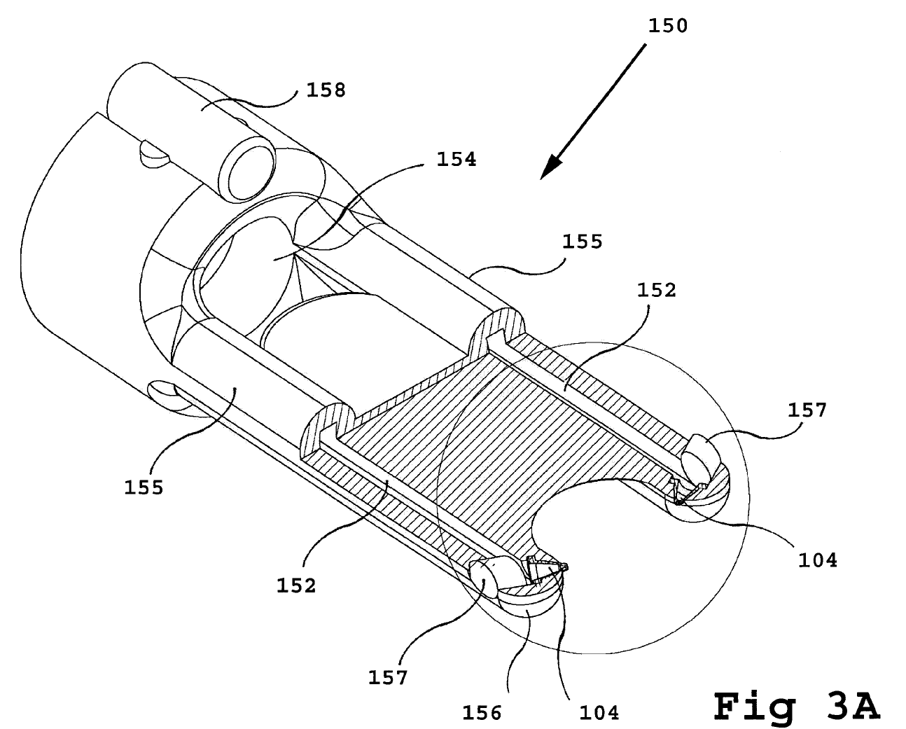

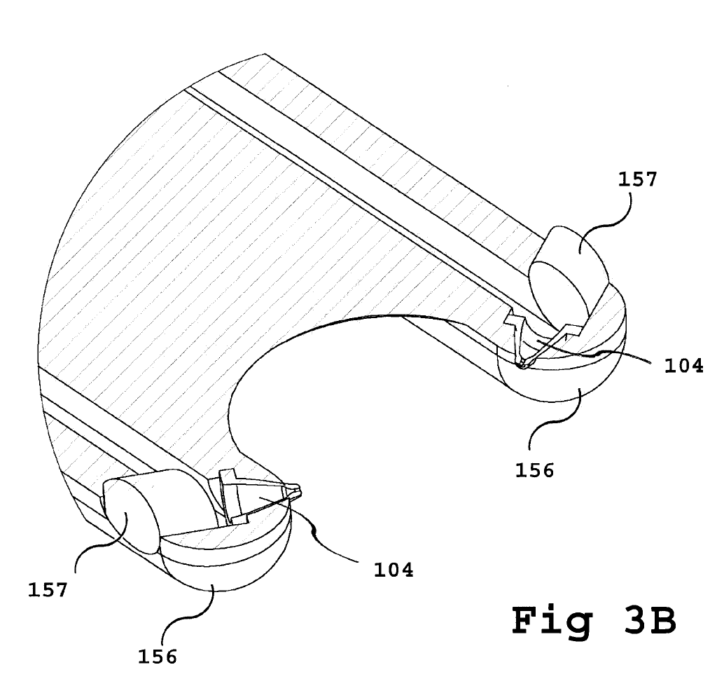

Reference is now made to FIGS. 3A and 3B where the former shows a cut away view of liquid jet dispenser 150. Liquid channels 152 are clearly seen as they extend and are in liquid communication with nozzles 104 at the distal end of dispenser 150. Liquid channels 152 are covered by liquid channel covers 155. Liquid channels 152 bring a working liquid from a liquid dispenser source (not shown) through liquid tube 122 (FIGS. 2A- 2B) to nozzle 104. Also readily seen is suction aperture 154 through which abraded debris and waste working liquid are removed via suction tube socket 158 into which suction tube 126 (FIGS. 2A-2B) has been glued or otherwise affixed. FIG. 3B is an enlarged view of the distal end 142 of liquid jet dispenser 150 shown in FIG. 3A. Stoppers 157 appear in FIGS. 3A and 3B and they plug apertures in dispenser 150 through which nozzles 104 are inserted at predetermined angles.

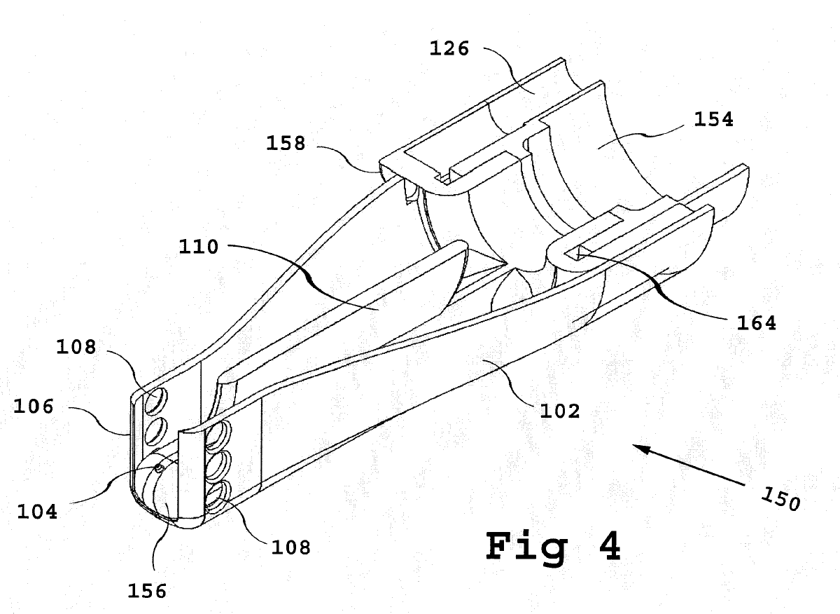

FIG. 4 to which reference is now made shows another cut-away view of liquid jet dispenser 150. In this Figure, rotated 90° counter clockwise from the figure in FIG. 3A, there is a better view of nozzle 104 in relation to spacer leg 156, spacer aperture 106 and air holes 108. There is an aileron stability support 110 which stabilizes liquid jet dispenser 150 during use. Also shown are liquid channel aperture 164 and suction tube 126 connected to suction tube socket 158. The liquid channel aperture 164 in connection with liquid channels 152 of FIG. 3A brings working liquid to nozzles 104. Waste working liquid and abrasion debris collects in suction aperture 154 from where it is suctioned off by suction tube 126 positioned in suction tube socket 158.

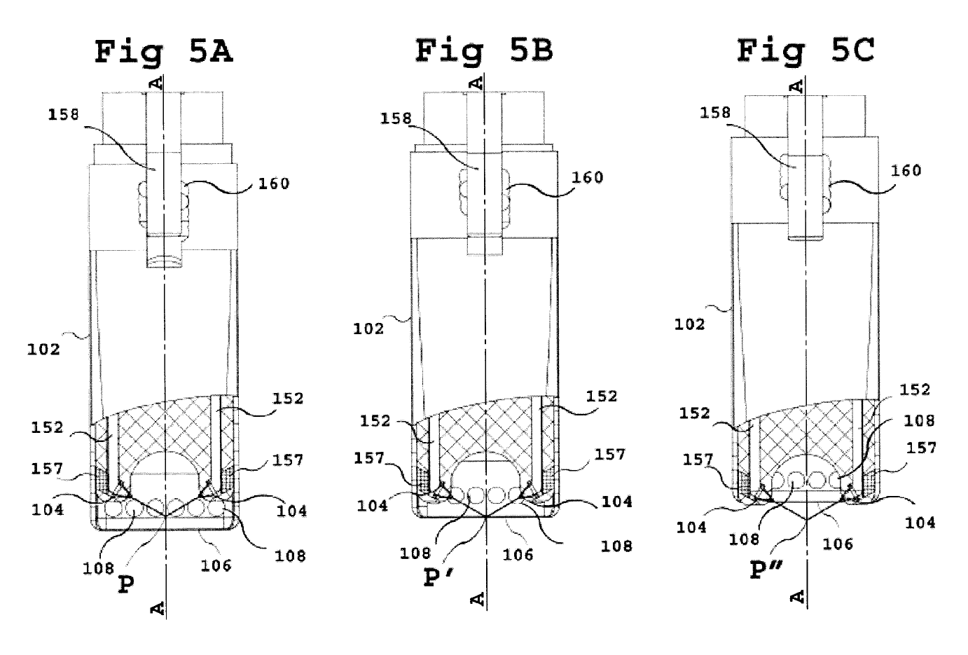

Turning now to FIGS. 5A-5C we can see the change in the depth of abrasion as spacer element 102 is moved in the proximal direction. Studying FIGS. 5A-5C, it can readily be seen that as spacer element 102 moves in the proximal direction, the common intersection point (P to P′ to P″, respectively) of the liquid jets impinging on the target material advances from the target's surface to a point further and further beneath its surface. Varying positions of movable spacer element 102 is achieved by moving spacer element 102 from one to another of a series of spacer positioning slots 160. The “AA” axis represents the assembly axis also referred to as the longitudinal or principal axis of the device.

In the embodiment shown in FIGS. 2A through 5C, spacer element 102 may be moved in the distal or proximal directions manually. In other embodiments, any of many different readily constructed pulling/pushing means known to persons skilled in the art may be included in liquid cutting device 100 and used to move spacer element 102, thereby controlling the depth of the cutting operation. In all of its various positions, spacer element 102 is held up against or adjacent to the surface of the material or tissue being cut. In moving from FIG. 5A to FIG. 5B and then to FIG. 5C, the liquid cutting device effects mild, moderate and aggressive abrasion, respectively.

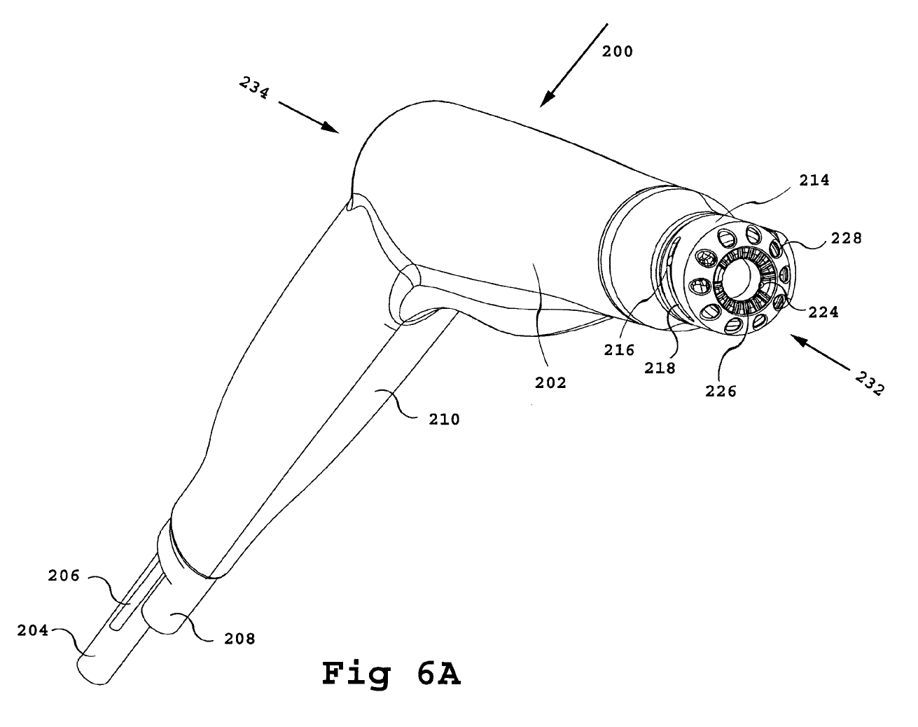

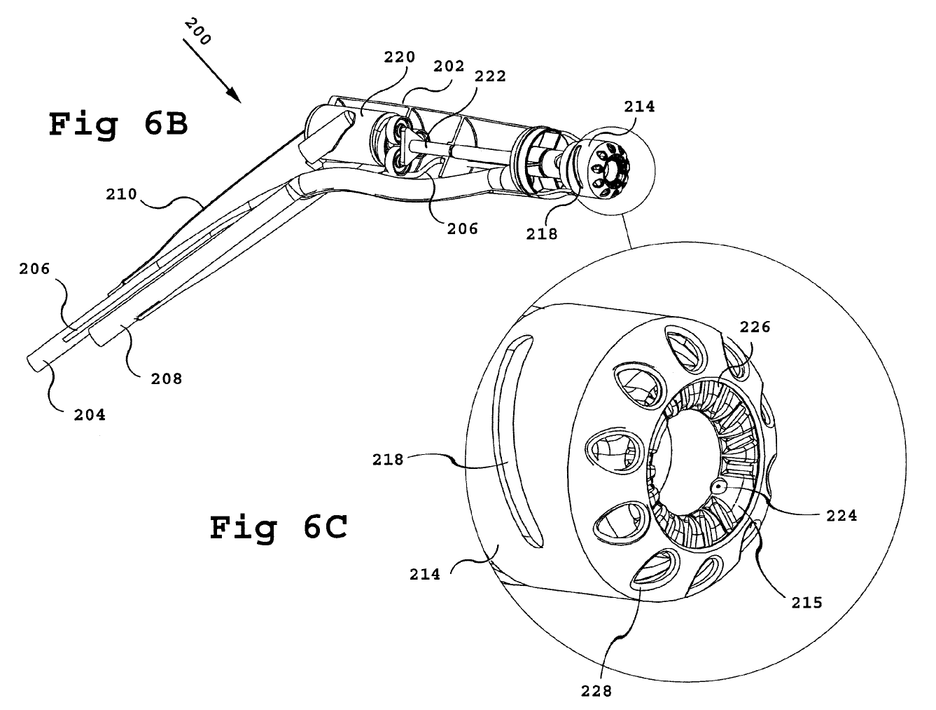

Reference is now made to FIGS. 6A-6C. FIG. 6A shows an overview of a liquid cutting device 200 having a liquid jet dispenser 215 (FIG. 6C) constructed according to a second embodiment of the present invention. FIG. 6B is a partial cut-away view of the device in FIG. 6A. FIG. 6C shows an enlarged view of the liquid jet dispenser 215 and spacer element 214 of device 200 shown in FIGS. 6A and 6B.

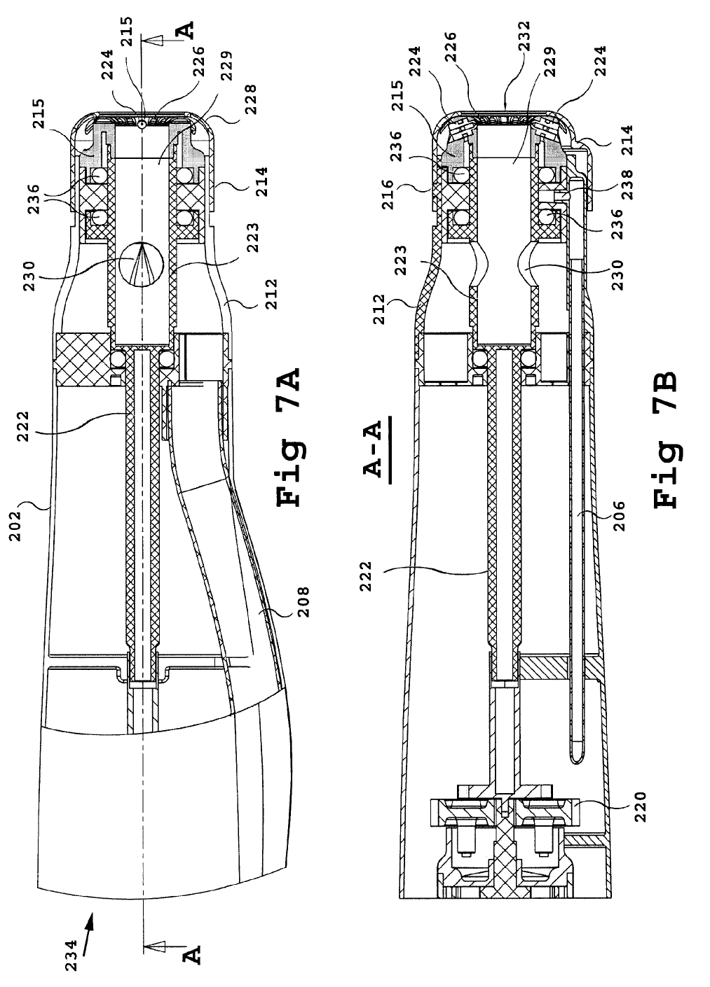

As in the prior embodiment, the distal end of device 200 in FIGS. 6A-6C contains a jet nozzle dispenser 215 which includes a nozzle assembly comprising two jet nozzles, configured to emit liquid jets. In this embodiment, the plurality of nozzles of the nozzle assembly are distributed evenly in a circle and connected to a pressurized working liquid source. The trajectories of the liquid jets emitted from the nozzles intersect at a point located on an axis “AA” (best seen in FIG. 7A) passing through the center of the circle and normal to the circle's plane. The nozzles are positioned to produce liquid jets having the same angle of incidence at their common intersection point. This sloping alignment allows the jets to symmetrically abrade tissue or other target material. When the liquid jets impinge on each other at the intersection point, the jets disperse, lose velocity, lose hydrodynamic stability, lose energy by using the energy to atomize the liquid, and lose their ability to cut.

Spacer element 214 is movably positionable much as in FIGS. 5A-5C of the first embodiment. Moving spacer element 214 to or from the distal end 232 of device 200 allows for regulation of the penetration depth of the jets, i.e. the depth of the intersection point of the jets within the target material being cut. Movement of spacer element 214 results from manually adjusting the position of a tenon 216 (FIG. 6A), an extension of stator shell 212 (FIGS. 7A-7B), in tenon slot 218. Slot 218 has a pitch allowing for spacer element 214 to move relative to the distal end 232 of jet dispenser 215. The depth of cutting below the surface of the target material increases as spacer element 214 is retracted away from the distal end of device 200.

Inter alia spacer element 214 and jet dispenser 215 minimize splashing of waste working liquid and abraded debris, preventing contamination of the environment. As in the previous embodiment, due to the angle between the liquid jet flows and the surface of the target material, solid debris from the cutting operation has a reflection vector backward from the target. Waste working liquid and solid debris are carried away by suction through detritus collection aperture 230 (best seen in FIGS. 7A-7B). As in the previous embodiment, an atmospheric air flux enters device 200 through air holes 228 in spacer element 214, the holes 228 located near the distal end of device 200.

FIGS. 6A and 6B show liquid cutting device 200 as having an upper 202 and lower 210 housing in which are positioned a compressed air channel 204 connected to a compressed air source (not shown), a liquid channel 206 connected to a liquid source (not shown), and a vacuum channel 208 connected to a vacuum source (not shown). Channels 204, 206 and 208 enter from the distal end 234 of device 200.

Positioned in upper housing 202 is also a driver element 220 (FIG. 6B), typically a compressed air vane motor, which is in mechanical connection to a drive shaft 222 (FIG. 6B). In some embodiments, a DC motor, vacuum vane motor or any other suitable motor may be used instead of a compressed air van motor indicated as driver element 220. In some embodiments, the drive shaft is a flexible drive shaft.

Driver element 220 and drive shaft 222 are in mechanical communication with jet dispenser 215. FIG. 6C best shows liquid jet dispenser 215 containing the nozzle assembly comprised of a plurality of nozzles 224 and air slots 226. Dispenser 215, in mechanical connection with rotor element 223 (best seen in FIGS. 7A and 7B), rotates, the rotation being driven by drive shaft 222. Rotation of jet dispenser 215 allows for better coverage of the area to be abraded and it allows for larger areas to be exposed to the action of the jets. Rotation effectively produces pulse-like periodic impingement of the liquid jets on the target area to be cut. It should be appreciated that rotor element 223 may be integrally formed with drive shaft 222 or affixed thereto as by welding or other methods known to persons skilled in the art.

As noted above, at the distal end 232 of spacer element 214 are a plurality of air holes 228. Air entering through air holes 228 passes through air slots 226 which are located between nozzles 224 of dispenser 215. In FIGS. 6A-6C, only one of the pair of nozzles 224 is seen. The liquid jets produced by nozzles 224 meet at a single intersection point. It should readily be appreciated that in other embodiments, there may be more than two nozzles with the liquid jets from the nozzles meeting at a single intersection point.

When device 200 is in use, distal end 232 of device 200 contacts, the target material to be abraded in a manner similar to that discussed in the embodiment of FIGS. 2A-5C.

It should be appreciated that since the distal end of the jet dispenser contacts the target surface, air holes 228 cannot directly provide air to the inside of the device. Air slots 226 of the jet dispenser 215 and the target surface provide an entryway for air. Air passes through air holes 228, flows within the space between spacer element 214 and jet dispenser 215, and from there flows through air slots 226 into a dispenser cavity 229 (FIG. 7A).

Reference is now made to FIGS. 7A and 7B which present side cut-away views of the embodiment in FIGS. 6A-6C. The two views are offset by 90°. The “AA” axis represents the assembly axis also referred to as the longitudinal or principal axis, of device 200. The numbering of elements already discussed in conjunction with FIGS. 6A-6C is identical to that of FIGS. 7A-7B. When liquid cutting device 200 is in use, pressurized liquid enters via liquid channel 206 through a liquid entrance passage 238 and from there passes to nozzles 224. It should readily be understood that although not readily seen, there are two liquid channels each associated with a different nozzle. The liquid channels in the present embodiment appear as channels because of the view. In reality, they represent a cylindrical channel located beneath rotary jet dispenser 215. O-rings 236 are used to effectively seal and contain the entering liquid as it passes through liquid entrance passage 238. Waste working liquid from the dispersed liquid jet and debris produced by the abrasion process are suctioned off through dispenser cavity 229 and conveyed through vacuum channel 208 (FIG. 7A) via detritus collection aperture 230.

The vacuum, compressor, and water systems of the embodiment of FIGS. 6A-7B may be activated by a foot pedal in contrast to the manually operated embodiment discussed above in conjunction with FIGS. 2A-5C.

Liquid channels 206 at both the distal and proximal ends of device 206 form what is herein denoted as an apparatus for delivering the pressurized working liquid from a liquid source (not shown) to nozzles 224.

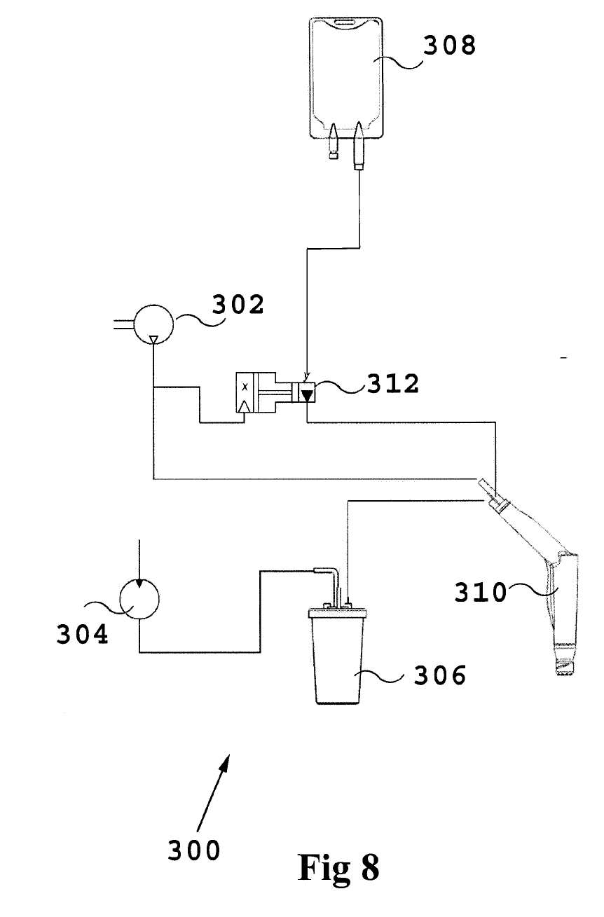

FIG. 8, to which reference is now made, is a schematic diagram of a system 300 for employing a liquid cutting device 310 constructed according to embodiments of the present invention. A vacuum pump 304 is connected to the liquid cutting device 310 via debris collection jar 306. Debris and waste liquid are suctioned from liquid cutting device 310 by vacuum pump 304 into jar 306. A liquid which may be water, saline solution or a solution of a medicament, vitamin or other soluble material (or even a liquid containing an abrasive material) is provided by liquid dispenser source 308. It is connected via air amplifier/booster 312 to liquid cutting device 310. A pressurized air source, such as a compressor 302, is connected directly to liquid cutting device 310 and indirectly to liquid cutting device 310 via air amplifier/booster 312. Amplifier/booster 312 receives pressurized air from pressurized air source 302 and increases its pressure. The high pressure liquid from liquid dispenser source 308 enters a jet dispenser (not shown) at the distal end of liquid cutting device 310. Liquid jets are emitted from a nozzle assembly (not shown) in the jet dispenser, the assembly containing a plurality of jet nozzles, such as nozzles 104 (FIG. 3A and FIG. 3B) or nozzles 224 (FIGS. 6A and 6C).

The part of the pressurized air provided directly to liquid cutting device 310 by pressurized air source 302 activates an air motor such as the one in device 200 discussed in conjunction with FIG. 6A-7C. It should be appreciated that when an embodiment such as that discussed in conjunction with FIGS. 2A-5C is used, the direct connection from the pressurized air source 302 to device 310 is not required.

A wide variety of vacuum pumps, air compressors and air pressure amplifier/boosters required for the system shown in FIG. 8 are readily available commercially as is known to persons skilled in the art. These pumps, compressors and amplifier/boosters are used with prior art water jet devices. A typical, but non-limiting, air compressor that can be used is Model OF 302 of Jun-Air International A/S, Norresundby, Denmark. Similarly, a typical, but non-limiting, air operated booster/ amplifier that can be used is an M Series 1/3 HP (0.25 kw) air driven liquid pump produced by Haskel International Inc., Burbank Calif. and a typical, but non-limiting, vacuum pump which can be used is pump VP0945, MEDO USA Inc., Hanover Park, Ill. These apparatuses are exemplary only and a plethora of similar commercially available instruments may be used as substitutes.

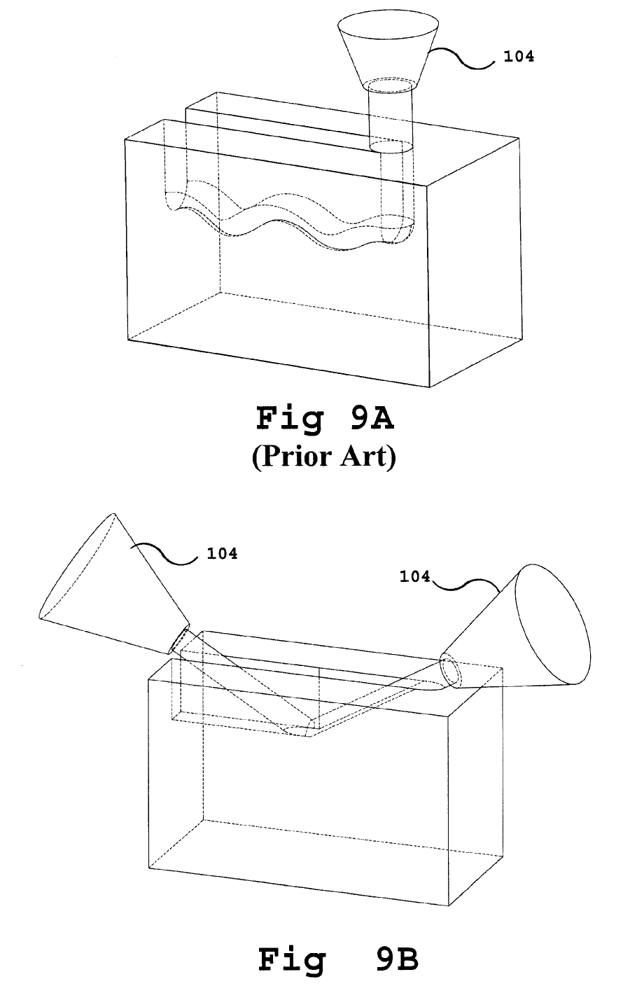

Reference is now made to FIGS. 9A and 9B where the difference between the mode of operation of devices constructed according to the present invention versus the mode of operation of prior art devices is shown. In prior art, as reflected in FIG. 9A, a single liquid jet nozzle is used and usually positioned substantially transverse to the surface being cut. In such a configuration, when moving from point to point in a plane substantially parallel to the surface of the target material to be cut, such as by using x,y steppers or positioners, there is a likelihood that the natural deviations in the properties of the target material along the paths of the liquid jet streams will effect cutting depth, leading to irregularities in the depth.

When jet nozzle assemblies constructed according to the present invention are used as shown in FIG. 9B, the natural variation in the properties of the target material may be minimized because of the oblique angle of incidence of the impinging plurality of liquid jets. A more uniform, i.e. level, abraded, ablated or cut surface is obtained. When used in surgical procedures, the configuration of the present invention prevents unwanted cutting of healthy tissue along with the desired cutting of diseased tissue.

It should be appreciated that since two or more liquid jet nozzles are required in the present invention, the power needed for each of the plurality of jet nozzles is less than when a single jet nozzle is used. Less pressure provides a cost savings since less expensive compressor/pumps may be used.

It should readily be understood that those parts of a liquid cutting device constructed according to the present invention that contact a patient undergoing a surgical procedure or that come in contact with debris produced during a surgical procedure may be constructed of inexpensive materials, such as plastic materials, so that such parts may be used only once before discarding.

The present invention also provides a method for cutting a target material with a liquid cutting device including a spacer element having a distal edge and a plurality of nozzles, each nozzle emitting a pressurized liquid jet stream from its jet emitting end, the jet streams intersecting at a predetermined intersection point. The method comprises the steps of: adjusting the position of the spacer element so that the plurality of nozzles is spaced from the distal edge of the spacer element such that the position of the intersection point of the liquid jet streams allows for a preselected cutting depth within the target material; placing the distal edge of the spacer element so as to contact the target material; and activating the device.

The method may further include the step of: deactivating the device and repeating the steps of adjusting, placing and activating, wherein the step of deactivating and repeating is repeated as often as required.

The step of adjusting may include the step of translating the spacer element so that the position of the intersection point of the liquid jet streams emitted from the plurality of nozzles allows for cutting at the preselected cutting depth within the target material.

The step of adjusting may include the step of rotating the spacer element so that the position of the intersection point of the liquid jet streams emitted from the plurality of nozzles allows for cutting at the preselected cutting depth within the target material.

The method may further include the step of activating a suction source for suctioning off waste working liquid and debris produced by cutting the target material.

The method may further include the step of translating the device in a direction substantially along a line within a plane containing the jet emitting ends of two nozzles and the predetermined intersection point. As a result, a long narrow trench as discussed in conjunction with FIG. 1E may be produced.

The method may further include the step of translating the device substantially normal to a plane containing the jet emitting ends of two nozzles and the intersection point. As a result, a substantially triangular prismatic or synclinal-shaped trough as discussed in conjunction with FIG. 1 E may be produced.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention. Therefore, it will be appreciated by persons skilled in the art that the present invention is not limited by what has been particularly shown and described herein above. Rather, the scope of the invention is defined by the claims that follow.

What is claimed is:

1. A liquid cutting device employing a pressurized working liquid which comprises:
a nozzle assembly comprising a plurality of liquid jet nozzles, each nozzle having a nozzle axis, said plurality of nozzles arranged so that said nozzle axes intersect at an intersection point located at a predetermined distance downstream from said nozzles; and
apparatus for delivering the pressurized working liquid to said plurality of liquid jet nozzles, each said nozzle being configured to selectably emit a liquid jet operative to cut through a target material,
wherein the liquid jets interfere and disperse each other when meeting at the intersection point.

2. A liquid cutting device according to claim 1, wherein said plurality of nozzles is arranged about an assembly axis which intersects with said nozzle axes at the intersection point, and said nozzles lie in a jet emission plane normal to said assembly axis and spaced from the intersection point, and wherein the available cutting depth of said cutting device is not greater than the axial distance from the jet emission plane to the intersection point.

3. A liquid cutting device according to claim 2, further including a spacer element adjustably mounted onto said nozzle assembly, said spacer element being selectably extendable such that a front end portion thereof extends beyond the jet emission plane towards the intersection point, thereby increasing the available cutting depth to a desired cutting depth.

4. A liquid cutting device according to claim 3, wherein said spacer element is a translationally movable element.

5. A liquid cutting device according to claim 3, wherein said spacer element is a rotationally movable element.

6. A liquid cutting device according to claim 3, wherein said spacer element further includes a plurality of apertures to allow entry of air which under suction carries away the debris of the cutting process and waste working liquid.

7. A liquid cutting device according to claim 6, wherein said nozzle assembly is positioned in a jet dispenser element, said dispenser element including a plurality of slots to allow entry of air which under suction carries away the debris of the cutting process and waste working liquid.

8. A liquid cutting device according to claim 3, further in vacuum communication with a vacuum source operative to suction off waste working liquid and debris resulting from the cutting operation.

9. A liquid cutting device according to claim 3, wherein said device further includes a driver element in mechanical communication with said nozzle assembly thereby to rotate said assembly allowing said nozzles positioned therein to cut a three-dimensional conical section.

10. A liquid cutting device according to claim 1, further including a spacer element adjustably mounted onto said nozzle assembly, said spacer element being selectably extendable such that a front end portion thereof extends beyond said plurality of nozzles in the direction of the intersection point, thereby varying the available cutting depth to a desired cutting depth.

11. A liquid cutting device according to claim 1, further in vacuum communication with a vacuum source operative to suction off waste working liquid and debris resulting from the cutting operation.

12. A liquid cutting device according to claim 1, wherein the target material is mammalian tissue.

13. A method for cutting a target material with a liquid cutting device including a spacer element having a distal edge and a plurality of nozzles, each nozzle emitting a pressurized liquid jet stream from its jet emitting end and the plurality of jet streams intersecting at a predetermined intersection point, the method comprises the steps of:
adjusting the position of the spacer element so that the plurality of nozzles is spaced from the distal edge of the spacer element such that the position of the intersection point of the liquid jet streams allows for a preselected cutting depth within the target material;
placing the distal edge of the spacer element so as to contact the target material; and
activating the device.

14. A method according to claim 13 further including the step of:
deactivating the device and repeating said steps of adjusting, placing and activating,
wherein said step of deactivating and repeating is repeated as often as required.

15. A method according to claim 13, wherein said step of adjusting includes the step of translating the spacer element so that the position of the intersection point of the liquid jet streams emitted from the plurality of nozzles allows for the preselected cutting depth within the target material.

16. A method according to claim 13, wherein said step of adjusting includes the step of rotating the spacer element so that the position of the intersection point of the liquid jet streams emitted from the plurality of nozzles allows for the preselected cutting depth within the target material.

17. A method according to claim 13, further including the step of activating a suction source for suctioning off waste working liquid and debris produced by cutting the target material.

18. A method according to claim 13, further including the step of translating the device in a direction substantially along a line within a plane containing the jet emitting ends of two nozzles and the predetermined intersection point.

19. A method according to claim 13, further including the step of translating the device in a direction substantially normal to a plane containing the jet emitting ends of two nozzles and the predetermined intersection point.
